(19) United States
(12) Patent Application Publication
(10) Pub. No.: US 2022/0261879 A1
(43) Pub. Date: Aug. 18, 2022

(54) CUSTOMER SERVICE SYSTEM

(71) Applicant: Tsutomu MORI, Osaka (JP)

(72) Inventor: Tsutomu MORI, Osaka (JP)

(21) Appl. No.: 17/223,003

(22) Filed: Apr. 6, 2021

(30) Foreign Application Priority Data
Feb. 18, 2021 (JP) 2021-23986

(51) Int. Cl. G06Q 30/06

(52) U.S. Cl. CPC G06Q 30/0641; G06Q 30/0639

(57) ABSTRACT

Provided is a customer service system capable of improving customer service. A customer service system 10 is for use when a user visits a physical store for shopping and comprises: a mobile terminal 4 having a display unit; an input unit 12 through which the user inputs input information relating to a product of interest; and a product guidance unit 14 for displaying, on the display unit on the basis of the input information input through the input unit 12, guidance to help the user find the product of interest in the physical store.

### CROSS-REFERENCES TO RELATED APPLICATIONS

This patent specification is based on Japanese patent application, No. 2021-23986 filed on Feb. 18, 2021 in the Japan Patent Office, the entire contents of which are incorporated by reference herein.

### BACKGROUND OF THE INVENTION

### 1. Field of the Invention

The present invention relates to a customer service system.

### 2. Description of Related Art

Traditionally, consumer products such as clothing have been sold in specialty stores (e.g., department stores, home improvement centers, drug stores) and physical stores (e.g., shopping malls). A problem that such stores have encountered is complaints about poor customer service by employees and about difficulties in finding products that meet the needs of consumers and customers (users).

One example of techniques related to the present invention is a sales promotion system disclosed in Patent Document 1. The sales promotion system uses a computer network to provide a consumer with sales promotion information for inducing consumption and promoting sales, and is provided with: a scene-dependent information provision means for providing the consumer with the sales promotion information in a suitable form for each of a plurality of scenes in each which the consumer does a specific action; and a machine learning means that applies artificial intelligence to perform machine learning on the basis of behavioral data of the consumer and that reflects the learning results to the provision of the sales promotion information at the plurality of scenes. The machine learning means performs machine learning on the basis of the behavior of the consumer following the provision of the sales promotion information at the plurality of scenes.

Patent Literature 1: JP 2019-28899 A

### BRIEF SUMMARY OF THE INVENTION

In physical stores, nearly 90% of customer service is just providing customers (users) with information on products that the customers wish to purchase, and in most cases, employees of the stores do not suggest other products that may meet the needs of the customers (users), thereby failing to improve customer satisfaction.

The purpose of the present invention is to provide a customer service system capable of improving customer satisfaction.

A customer service system according to the present invention is for use when a user visits a physical store for shopping and comprises: a mobile terminal having a display unit; an input unit through which the user inputs input information relating to a product of interest; and a product guidance unit for displaying, on the display unit on the basis of the input information input through the input unit, guidance to help the user find the product of interest in the physical store.

In the customer service system according to the present invention, the product guidance unit preferably causes the display unit to display a location where the product of interest is present in the physical store.

In the customer service system according to the present invention, the product guidance unit preferably causes the display unit to display detailed product information relating to the product of interest.

Preferably, the customer service system according to the present invention further comprises a salesperson calling unit for enabling the user to call a salesperson working in the physical store.

In the customer service system according to the present invention, the product guidance unit preferably suggests a product that may correspond to the product of interest of the user on the basis of at least one of purchase data, product data, market data, trend data, weather temperature data, and unique data owned by an organization running the physical store.

Preferably, the customer service system according to the present invention further comprises a learning unit that learns the purchase data, the product data, the market data, the trend data, the weather temperature data, and the unique data while accumulating these data.

The present invention can improve customer satisfaction.

### BRIEF DESCRIPTION OF THE DRAWINGS

FIG. 1 is a view illustrating a customer service system according to an embodiment of the present invention.

FIG. 2 is a view illustrating a flow of processing the attribute of a user in the embodiment of the present invention.

### DETAILED DESCRIPTION OF THE INVENTION

Hereinafter, an embodiment of the present invention is described in detail with reference to the attached drawings. In the following description, like elements are assigned the same reference numerals in all drawings, and their descriptions will not be repeated. In the description, preceding reference numerals which have been used in preceding description may be used in subsequent description as necessary.

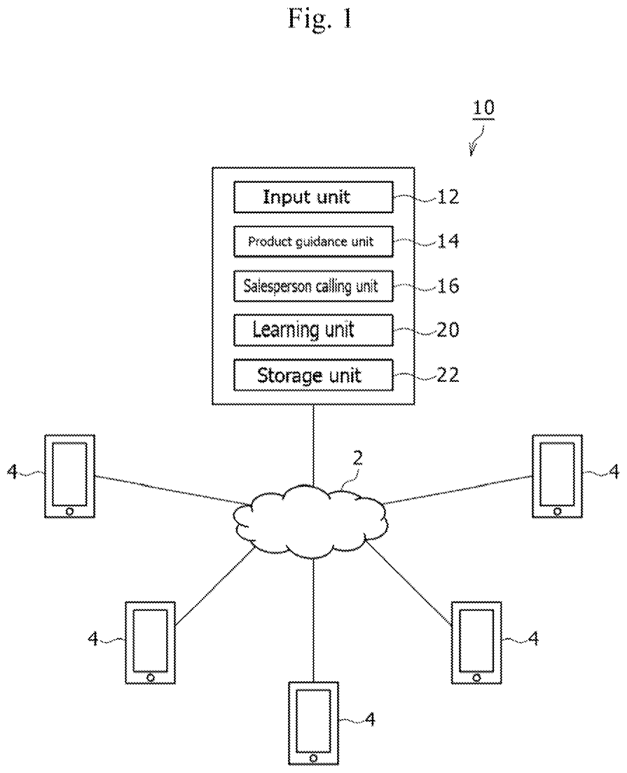

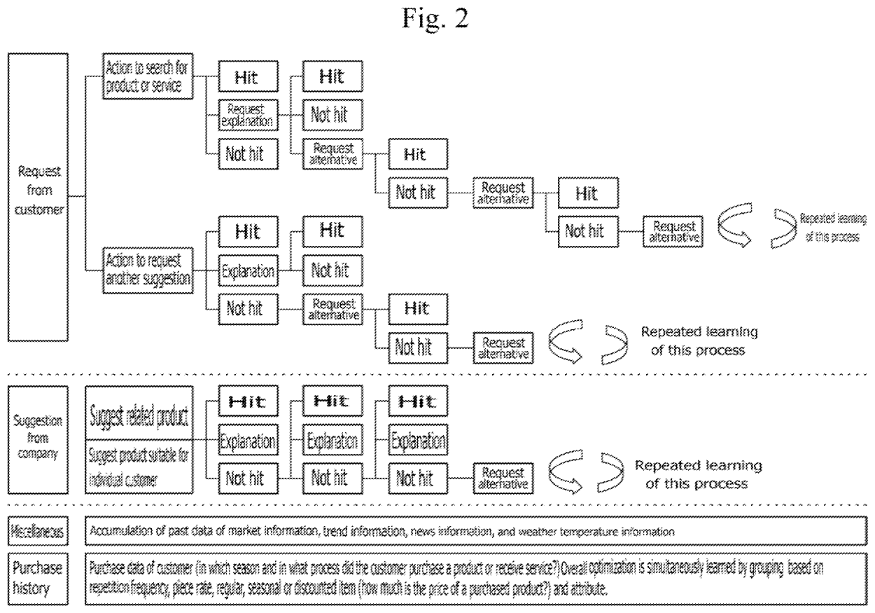

FIG. 1 is a view illustrating a customer service system 10 according to an embodiment of the present invention. FIG. 2 is a view illustrating a flow of processing the attribute of a user in the embodiment of the present invention.

The customer service system 10 is used when a user visits a physical store for shopping. The customer service system 10 is provided with an input unit 12, a product guidance unit 14, a salesperson calling unit 16, a learning unit 20, and a storage unit 22. These components are connected via a network 2 to a user's mobile terminal 4.

The network 2 is a communication infrastructure such as the internet. The user is a customer who uses the physical store. The user's mobile terminal 4 is a terminal having a display unit (e.g., liquid crystal screen), and examples thereof include smartphones and tablet PCs.

The input unit 12 is operable to receive an input of input information relating to a user's product of interest. If there is a product that the user wishes to purchase, the user inputs information on the product (e.g., brand name, product name, model number). As examples of the types of input, character input and speech input can be mentioned.

Additionally, the input unit can also receive an input for requesting display of a location where the product is present in the physical store.

The product guidance unit 14 is operable to display, on the display unit of the mobile terminal 4 on the basis of the input information input through the input unit 12, guidance to help the user find the product of interest in the physical store.

The product guidance unit 14 is operable to display, on the display unit of the mobile terminal 4, the location where the product of interest is present in the physical store.

Specifically, when the user requests the location of the product of interest using the function of the input unit 12, the product guidance unit 14 displays, on the display unit of the mobile terminal 4, the location of the product of interest in the physical store.

The product guidance unit 14 is operable to display detailed product information relating to the product of interest on the display unit of the mobile terminal 4.

Specifically, when the user has found an attractive product among products being sold in the physical store, the user should select the product, so that detailed information of the product (e.g., material, location of production, price, sales) is displayed on the display unit of the mobile terminal 4.

The product guidance unit 14 is operable to suggest a product that may correspond to the product of interest of the user on the basis of at least one of purchase data, product data, market data, trend data, weather temperature data, and unique data owned by an organization running the physical store.

The purchase data is accumulated data relating to products and the like purchased by the user. The analysis of this data makes it possible to suggest products that may fit the user's liking.

The product data is data relating to the functional properties and characteristics of products provided by companies (e.g., manufacturers of products). This data can be used to analyze, for example, which class or segment of customers the products attract and to analyze and suggest an effective way of suggestion (e.g., timing, suggesting method).

The market data and the trend data are accumulated data of trends in the world. The analysis of this data makes it possible to suggest a product that may solve some problems of the customer.

The weather temperature data is accumulated data of climate information including weather, temperature and humidity. The analysis of this data makes it possible to suggest an optimal product for the season.

The unique data is data accumulated by the organization running the physical store. The analysis of this data makes it possible to suggest a suitable product based on the attribute of the customer.

Besides the purchase data, the product data, the market data, the trend data, the weather temperature data, and the unique data, the product guidance unit 14 can use, for example, customer data and sales promotion data to suggest a product.

The product guidance unit 14 is operable to analyze the attribute of the user on the basis of, for example, customer data including the user's motivation and process of purchase of products and to provide a suggestion that may solve some problems of the user. The product guidance unit 14 is further operable to evaluate the effects of out-store promotion (OSP) and in-store promotion (ISP) and to suggest, on the basis of the resulting sales promotion data, sales promotion ways effective in the respective promotions.

The salesperson calling unit 16 is operable to enable the user to call a salesperson working in the physical store. Since the location of the product of interest or the detailed information of the product is displayed on the display unit of the mobile terminal 4 by the function of the product guidance unit 14, the user can learn the knowledge of the product even in the absence of any store salesperson before purchasing the product. In order for the user to have deeper knowledge or advice, the user can operate the salesperson calling unit 16 to call a salesperson in the physical store.

The learning unit 20 is operable to learn the purchase data, the product data, the market data, the trend data, the weather temperature data, and the unique data while accumulating these data. The learning unit 20 can be achieved using artificial intelligence.

An example of how the learning unit 20 learns is shown in FIG. 2. By repeatedly accumulating, for example, why a product was purchased (hit), why an explanation was requested (request explanation), why a product was not purchased (not hit), and which product or service was requested (request alternative), the learning unit learns the characteristics, thought and taste of the user.

The learning unit 20 determines the characteristics and attribute of the individual user (customer) on the basis of requests from the user and customer service language data provided by a company or the like, and more accurately determines the characteristics of the user using a combination of the customer service language data with the purchase history data and other data (market, trend, weather data). Additionally, on the basis of data of all users, the learning unit can analyze their customer attribute segment and taste depending on the attribute to associate them with marketing, products, and sales promotion strategies of the company.

The storage unit 22 is operable to accumulate the purchase data, the product data, the market data, the trend data, the weather temperature data, and the unique data.

In the customer service system 10, the functions of the units other than the storage unit 22 can be achieved by using either a hardware or a software. In one example using a software, the functions can be achieved on a server device provided with a CPU, MPU, RAM, ROM or the like by running an application program (customer service application) stored in a storage medium such as RANI, ROM, or a hard disk.

The following describes the advantages of the customer service system 10 having the above configuration. Traditionally, in specialty stores (e.g., department stores, home improvement centers, drug stores) and physical stores (e.g., shopping malls), customer service has been provided by salespersons. Unfortunately, nearly 90% of customer service is just providing users with customer guidance in the stores such as information on products that the users wish to purchase, and one problem to be solved is a comparatively high frequency of complaints about poor customer service by the salespersons.

Another problem is lack of manpower in physical stores, and workers cannot engage themselves fully in their own work to do. The customer service system 10 according to the present embodiment of the present invention is remarkably effective against such problems.

The user runs an application program (customer service application) in the mobile terminal 4 in a specialty store such as a department store, home improvement center, or drug store or in a physical store such as a shopping mall. On the basis of information input by the user using the input unit 12 or the like, a guidance that helps the user find a product of interest in the store is displayed on the display unit of the mobile terminal 4 by the function of the product guidance unit 14.

Accordingly, the user does not have to ask questions about anything to salespersons and can enjoy shopping without worrying about aggressive sales that force the user to purchase some unwanted products. The user can call a salesperson using the salesperson calling unit 16 in case that the guidance provided by the product guidance unit 14 is not sufficient.

Additionally, since the product guidance unit 14 is operable to suggest an optimal product for the user, the user can advantageously receive high-quality service and enjoy shopping. Another advantage is that the function of the product guidance unit 14 can prevent the user from forgetting to purchase what he/she wants.

One advantage for the organization running the physical store is that high-quality customer service is ensured regardless of the quality of customer service of salespersons. Another advantage is that the amount of time the salespersons spend for customer guidance in the store can be reduced and the salespersons can engage themselves in their own work to do. This leads to an effective distribution of management resources, thereby leading to significant cost savings.

Additionally, since an optimal product for the user can be suggested to the user, the number of products the user purchases can be increased while preventing the user from forgetting to purchase what he/she wants, and customer information can be obtained.

Furthermore, the function of the product guidance unit 14 enables the display unit to, for example, display characters of greeting with hospitality or output a sound of such greeting when the user enters or visits the physical store. This can enhance customer satisfaction, leading to enhanced customer adoption rates.

The function of the learning unit 20 and the above-described functions enable the customer service system to learn the purchase data, the product data, the market data, the trend data, the weather temperature data, and the unique data while accumulating these data. This enables one-to-one marketing.

By using the function of the product guidance unit 14, not only product guidance can be provided in the physical store but also notification such as newsletter or push notification from an application software can be provided to achieve customer lock-in.

The customer service system 10 can improve customer satisfaction of individual users and assists salesperson in providing higher quality customer service than a satisfactory level (expected), leading to creation of needs in the industry. Additionally, accumulation and learning of the data lead to a solution and to innovation in the future, and may bring light into the world. This is because by relying on the system in which the learning unit 20 analyzes massive big data and provides a suggestion, salespersons can spend their energy for the human originality and sense.

The customer service system 10 has been developed in light of the issues of physical stores. Since deepening the relationship with customers and knowing every detail lead to their good life, the system can also be used in EC business, and may further be expected to be used for fusion of physical stores and EC business.

Although in the above description, the customer service system 10 suggests a product suitable for a user, what is suggested may be service (including fee-based service). Among a variety of types of service, examples thereof include service relating to food, clothing and shelter such as delivery service, furniture or storage item assembling service, and repairing service.

### Description of Symbols

2: Network; 4: Mobile terminal; 10: Customer service system, 12: Input unit; 14: Product guidance unit; 16: Salesperson calling unit; 20: Learning unit; 22: Storage unit

1. A customer service system for use when a user visits a physical store for shopping comprises:
a mobile terminal having a display unit, the mobile terminal used by the user in the physical store;
an input unit through which the user inputs input information relating to a product of interest in the physical store;
a product guidance unit for displaying, on the display unit on the basis of the input information input through the input unit, guidance to help the user find the product of interest in the physical store^{.} and
a learning unit that accumulates purchase data, product data, market data, trend data, weather temperature data, and unique data owned by an organization running the physical store, wherein
the product guidance unit causes the display unit to display detailed product information including a material and a location of production of the product of interest, and
the product guidance unit suggests a product that may correspond to the product of interest of the user on the basis of the purchase data, the product data, the market data, the trend data, the weather temperature data, and the unique data.

2. The customer service system according to claim 1, wherein the product guidance unit causes the display unit to display a location where the product of interest is present in the physical store.

3. (canceled)

4. The customer service system according to claim 1, further comprising a salesperson calling unit for enabling the user to call a salesperson working in the physical store.

5-6. (canceled)
